(19) United States
(12) Patent Application Publication
(10) Pub. No.: US 2005/0111766 A1
(43) Pub. Date: May 26, 2005

(54) Fluid dynamic pressure bearing device, motor, and recording medium driving device

(76) Inventors: Hiromitsu Gotoh, Chiba-shi (JP); Atsushi Ohta, Chiba-shi (JP); Kazuaki Oguchi, Chiba-shi (JP); Shinji Kinoshita, Chiba-shi (JP)

Correspondence Address: ADAMS & WILKS, 31st Street, 50 Broadway, New York, NY, 10004, US

(21) Appl. No.: 10/647,947

(22) Filed: Aug. 26, 2003

(30) Foreign Application Priority Data
Aug. 28, 2002 (JP) 2002-249535
Mar. 19, 2003 (JP) 2003-075301

(51) Int. Cl. F16C 32/06

(52) U.S. Cl. 384/100

(57) ABSTRACT

Disclosed is a fluid dynamic pressure bearing device rotatably supporting a shaft member by dynamic pressure of a liquid such as oil or water filling the clearance between the shaft member and a shaft member support portion, in which it is possible to maintain bearing properties of the fluid dynamic pressure bearing device for a long period of time. The fluid dynamic pressure bearing device includes: a shaft member having a columnar portion formed substantially in a columnar configuration; a shaft member support portion having a shaft portion insertion hole for accommodating the shaft member; and a dynamic pressure generating portion formed by filling a clearance defined between the shaft member and the shaft member insertion hole with a liquid, with at least one of the surface of the shaft member and the inner wall surface of the insertion hole being equipped with a dynamic pressure generating groove for collecting the liquid to generate dynamic pressure when the shaft member is rotated, in which an annular shaft member protrusion protruding radially outwards is provided on an outer peripheral surface of the columnar portion situated axially on an outer side of the dynamic pressure generating portion.

### BACKGROUND OF THE INVENTION

1. Field of the Invention

The present invention relates to a fluid dynamic pressure bearing device rotatably supporting a shaft member by dynamic pressure of a liquid filling a clearance between the shaft member and a shaft member support portion, a motor equipped with this fluid dynamic pressure bearing device, and a recording medium driving device equipped with this motor.

2. Description of the Related Art

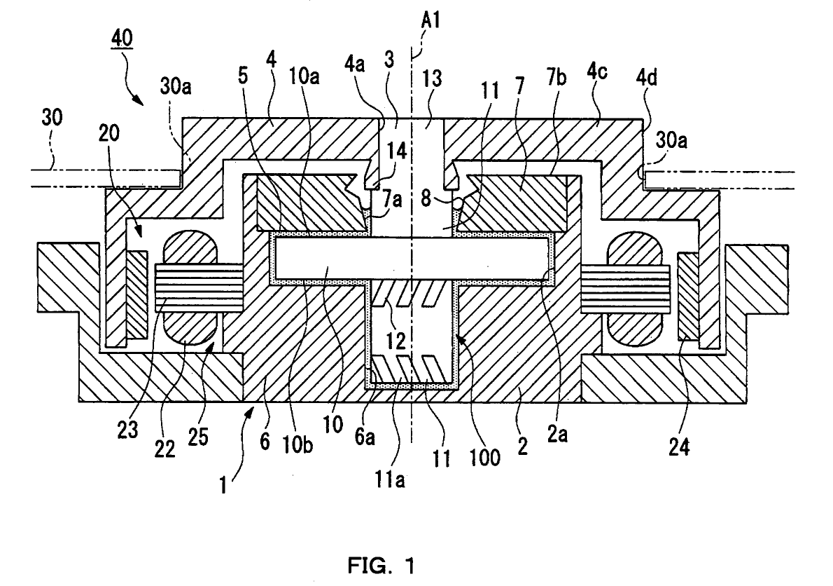

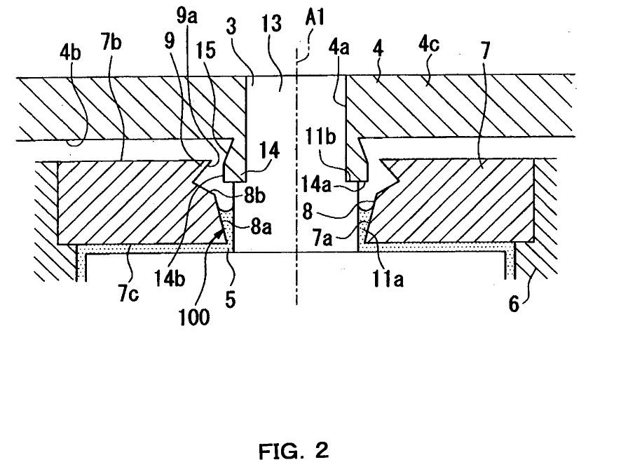

Recently, as a bearing adaptable to high speed motor rotation, there has been developed a fluid dynamic pressure bearing device utilizing a liquid, such as oil or water. In this fluid dynamic pressure bearing device, a clearance between a shaft member and a sleeve (shaft member support portion) is filled with liquid, and the shaft member and the sleeve are rotated relative to each other such that they do not come into contact with each other (See, for example, JP 10-73126 A (at pages 3 to 5, FIGS. 1 and 2)).

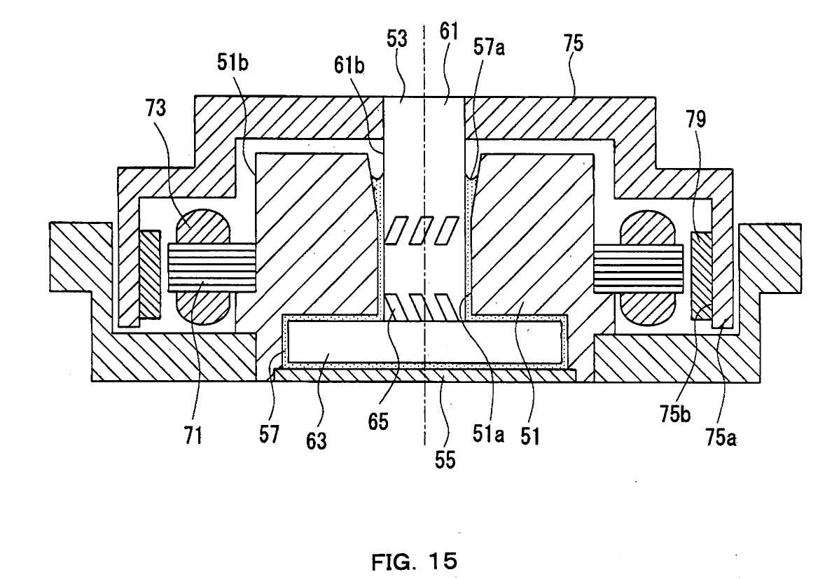

As shown, for example, in FIG. 15, a conventional fluid dynamic pressure bearing device is equipped with a sleeve 51 having a shaft member insertion hole 51a reverse-T-shaped in section, a shaft member 53 reverse-T-shaped in section and inserted into the shaft member insertion hole 51a so as to leave a predetermined clearance therebetween, a counter plate 55 closing the lower end portion of the shaft member insertion hole 51a in the state in which the shaft member 53 has been inserted, and an oil 57 filling the clearance between the sleeve 51 and the shaft member 53.

The shaft member 53 is composed of a radial shaft portion 61 formed substantially in a columnar configuration and a thrust shaft portion 63 formed at the lower end of the radial shaft portion 61 substantially in a disc-like configuration. Dynamic pressure generating grooves 65 are formed in the surface 61a of the radial shaft portion 61 and in the obverse and reverse surfaces 63a of the thrust shaft portion 63.

Further, a core 71 and a coil 73 are provided on the outer peripheral surface 51b of the sleeve 51. A hub 75 is mounted to the upper end portion of the shaft member 53, and, of the cylindrical wall portion 75a of the hub 75, the inner peripheral surface 75b opposed to the core 71 and the coil 73 is equipped with a magnet 79. An alternating magnetic field generated in the core 71 and the coil 73 is applied to the magnet 79, whereby the shaft member 53 and the hub 75 rotate.

When the shaft member 53 rotates, the oil 57 is collected in the dynamic pressure generating grooves 65 to generate dynamic pressure. Due to the dynamic pressure, the sleeve 51 rotatably supports the shaft member 53.

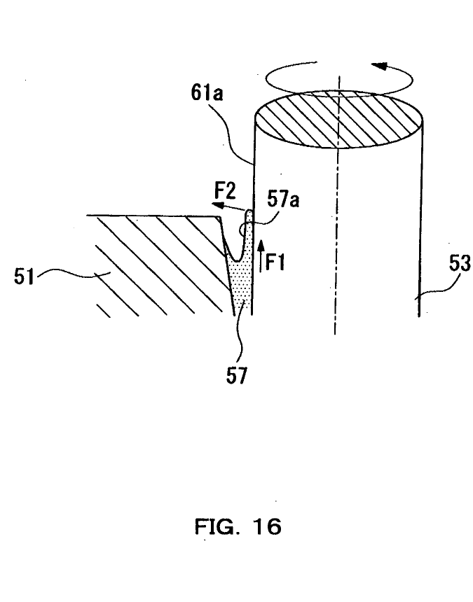

As shown in FIG. 16, in the conventional fluid dynamic pressure bearing device, the oil 57 is attracted to the surface 61a side of the shaft member 53 as the shaft member 53 rotates, so that the liquid level 57a of the oil 57 on the shaft member 53 side rises in the axial direction (as indicated by an arrow F1). When the rising oil 57 gathers in a fixed amount in the vicinity of the upper end of the shaft member 53, the oil is scattered outwards (as indicated by an arrow F2) from the clearance between the shaft member 53 and the sleeve 51 due to the centrifugal force of the shaft member 53, resulting in oil leakage.

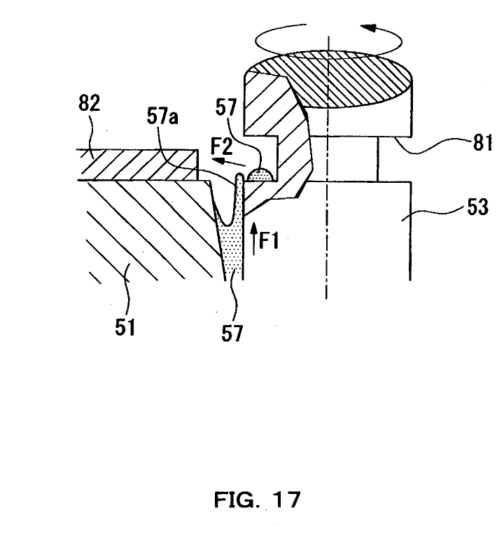

Further, as shown in FIG. 17, in the above-described conventional bearing device, a method is proposed according to which the rise of the liquid level 57a of the oil 57 is restrained by forming an oil cutoff groove 81 in the upper end portion of the shaft member 53. In this case, however, when the amount of oil 57 thus rising exceeds a fixed level, some oil enters the oil cutoff groove 81, and when the amount of oil 57 entering the oil cutoff groove 81 exceeds a fixed level, the oil 57 is scattered outwardly from the clearance by the centrifugal force of the shaft member 53.

Further, according to the above method, outward oil leakage is prevented by trapping the oil scattered outwards from the clearance by an absorption cloth 82. In this case, however, there is a fear of the oil 57 filling the clearance being reduced to make it impossible to provide the requisite amount of oil for the fluid dynamic pressure bearing device.

Under the circumstances described above, it is impossible to maintain the bearing properties of the fluid dynamic pressure bearing device for a long period of time.

### SUMMARY OF THE INVENTION

The present invention has been made in view of the above problems in the prior art. It is an object of the present invention to provide a fluid dynamic pressure bearing device capable of maintaining its bearing properties for a long period of time.

To achieve the above object, the present invention provides a fluid dynamic pressure bearing device, including: a shaft member having a columnar portion formed substantially in a columnar configuration; a shaft member support portion having a shaft portion insertion hole for accommodating the shaft member; and a dynamic pressure generating portion formed by filling a clearance defined between the shaft member and the shaft member insertion hole with a liquid, with at least one of a surface of the shaft member and an inner wall surface of the insertion hole being equipped with a dynamic pressure generating groove for collecting the liquid to generate dynamic pressure when the shaft member is rotated around its axis, the fluid dynamic pressure bearing device being characterized in that an annular shaft member protrusion protruding radially outwards is provided on an outer peripheral surface of the columnar portion situated axially on an outer side of the dynamic pressure generating portion.

In the fluid dynamic pressure bearing device according to the invention as described above, when the shaft member rotates around its axis, the shaft member support portion rotatably supports the shaft member by dynamic pressure.

Further, in this process, the liquid is attracted to the outer peripheral surface side of the columnar portion, and rises along the outer peripheral surface. The rising liquid adheres to the lower end portion side of the shaft member protrusion formed on the outer peripheral surface of the columnar portion and is accumulated there. When the amount of liquid thus accumulated exceeds a fixed level, the liquid drops by gravity and returns to the clearance between the shaft member and the shaft member insertion hole.

Further, the fluid dynamic pressure bearing device is characterized in that the shaft member protrusion has a liquid cutoff surface raised from the outer peripheral surface of the columnar portion toward the inner wall surface.

In the fluid dynamic pressure bearing device according to the invention as described above, the liquid adhering to the liquid cutoff surface of the shaft member protrusion moves along the liquid cutoff surface by the centrifugal force generated by the rotation of the shaft member. Thus, even if scattered outwards in the radial direction of the shaft member, the liquid adheres to the inner wall surface of the shaft member insertion hole, so that no liquid is scattered to the outside of the clearance.

Further, the cutoff surface is formed as a tapered inner surface whose diameter increases gradually along an axial direction of the shaft member toward the dynamic pressure generating portion.

In the fluid dynamic pressure bearing device according to the invention as described above, the liquid adhering to the tapered inner surface moves radially outwards along the tapered inner surface by the centrifugal force generated by the rotation of the shaft member, and moves toward the dynamic pressure generating portion, so that it can return to the clearance between the shaft member and the shaft member insertion hole.

Further, in the fluid dynamic pressure bearing device according to the present invention, an annular axial-support protrusion protruding radially inwards is provided on the inner wall surface situated on an axially outer side of the dynamic pressure generating portion and more spaced apart from the dynamic pressure generating portion than a position where an extension line of the liquid cutoff surface crosses the inner wall surface.

In the fluid dynamic pressure bearing device according to the invention as described above, if the liquid scattered from the liquid cutoff surface to adhere to the inner wall surface moves away from the dynamic pressure generating portion along the inner wall surface, the liquid will abut the lower end portion of the axial-support protrusion, so that no liquid scatters to the outside of the clearance. Further, when the amount of liquid adhering to and accumulated on the lower end portion side of the axial-support protrusion exceeds a fixed level, the liquid flows down by gravity and returns to the clearance between the shaft member and the shaft member insertion hole.

Further, in the fluid dynamic pressure bearing device, the inner wall surface of the insertion hole situated axially on the outer side of the dynamic pressure generating portion is equipped with a tapered inner wall surface whose diameter gradually decreases along the axial direction of the shaft member toward the dynamic pressure generating portion, and an outer inner wall surface adjacent to the tapered inner wall surface and situated so as to sandwich the tapered inner wall surface together with the dynamic pressure generating portion, in which one of the tapered inner wall surface and the outer inner wall surface crosses the extension line of the liquid cutoff surface, and in which an angle θ made by the tapered inner wall surface and the outer inner wall surface is in a range of 95°≦θ130°.

Further, the outer inner wall surface is formed so as to be substantially parallel to the axial direction of the shaft member.

In the fluid dynamic pressure bearing device according to the invention as described hereinabove, the liquid scattered from the liquid cutoff surface outwardly in the radial direction of the shaft member adheres to the tapered inner wall surface and the outer inner wall surface. Here, the reason for setting the angle θ of the corner portion formed by the tapered inner wall surface and the outer inner wall surface at 95° or more is to prevent a large amount of liquid from being accumulated in this corner portion due to surface tension when the liquid adhering to the tapered inner wall surface and the outer inner wall surface moves to reach the corner portion, thereby preventing the liquid from overflowing and scattering to the outside of the clearance between the shaft member and the shaft member insertion hole.

Further, the reason for setting the angle θ of the corner portion at 130° or less is to cause a small amount of liquid to stay due to surface tension when the liquid adhering to the tapered inner wall surface moves along the tapered inner wall surface to reach the corner portion, thereby preventing the liquid from easily getting over the corner portion and being scattered along the outer inner wall surface to the outside of the clearance between the shaft member and the shaft member insertion hole.

Further, when the outer inner wall surface is formed so as to be substantially parallel to the axial direction of the shaft member, the clearance between the outer inner wall surface and the shaft member protrusion can be made easily small, and this clearance can be made long easily along the axial direction. Thus, even if the liquid is heated to become a mist when the shaft member rotates, it is possible to easily restrain leakage of the liquid in the form of a mist to the outside from the clearance between the shaft member and the shaft member insertion hole.

Further, a motor according to the present invention is characterized in that the motor is equipped with the fluid dynamic pressure bearing device described above and driving means for rotating the shaft member with respect to the shaft member support portion.

In the motor according to the invention as described above, no liquid flows out of the clearance between the shaft member and the shaft member support portion when the shaft member rotates by driving force of the driving means, so that the bearing properties of the dynamic pressure generating portion do not change even if the motor is used for a long period of time. Thus, it is possible to realize a stable rotation of the shaft member.

Further, a recording medium driving device according to the present invention is characterized in that the recording medium driving device is equipped with the motor described above, and that a hub supporting a thin-plate-like recording medium is mounted to the shaft member.

In the recording medium driving device according to the invention as described above, no liquid flows out of the clearance between the shaft member and the shaft member support portion when the recording medium is rotated, so that no liquid adheres to the surface of the recording medium.

In the accompanying drawings:

FIG. 1 is a sectional view of a fluid dynamic pressure bearing device according to a first embodiment of the present invention;

FIG. 2 is an enlarged sectional view of a main portion of the fluid dynamic pressure bearing device of FIG. 1;

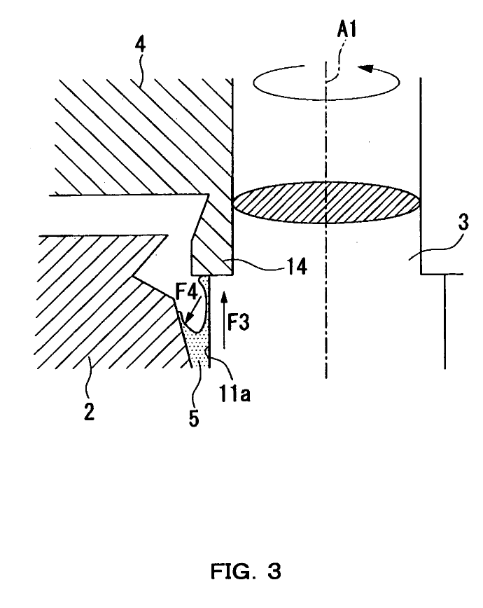

FIG. 3 is a schematic diagram illustrating how oil leakage is restrained in the fluid dynamic pressure bearing device of FIG. 1;

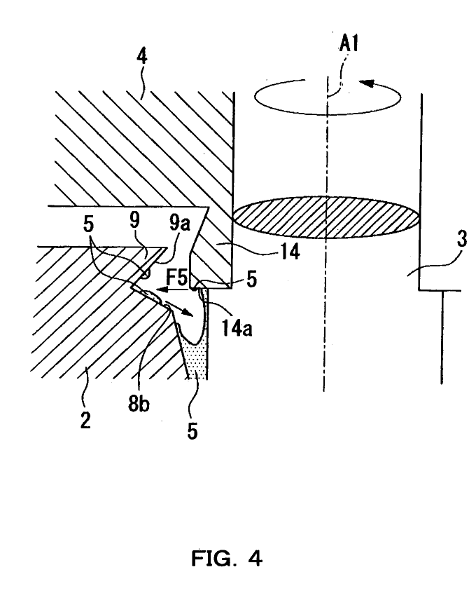

FIG. 4 is a schematic diagram illustrating how oil leakage is restrained in the fluid dynamic pressure bearing device of FIG. 1;

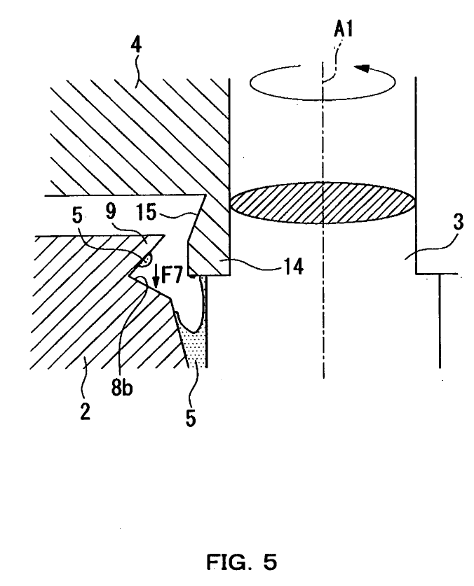

FIG. 5 is a schematic diagram illustrating how oil leakage is restrained in the fluid dynamic pressure bearing device of FIG. 1;

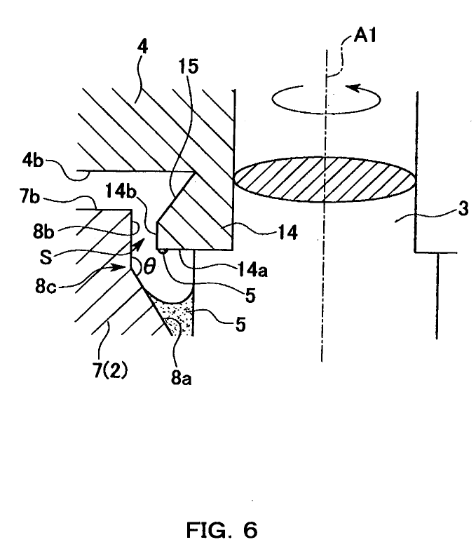

FIG. 6 is an enlarged sectional view of a main portion of a fluid dynamic pressure bearing device according to a second embodiment of the present invention;

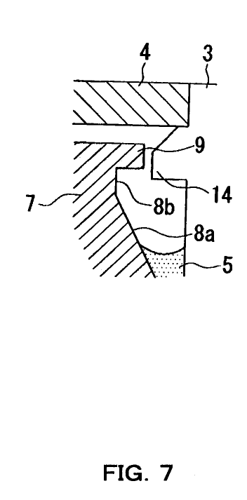

FIG. 7 is an enlarged sectional view of a main portion of a fluid dynamic pressure bearing device according to another embodiment;

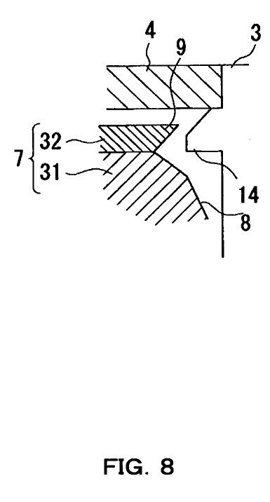

FIG. 8 is an enlarged sectional view of a main portion of a fluid dynamic pressure bearing device according to another embodiment;

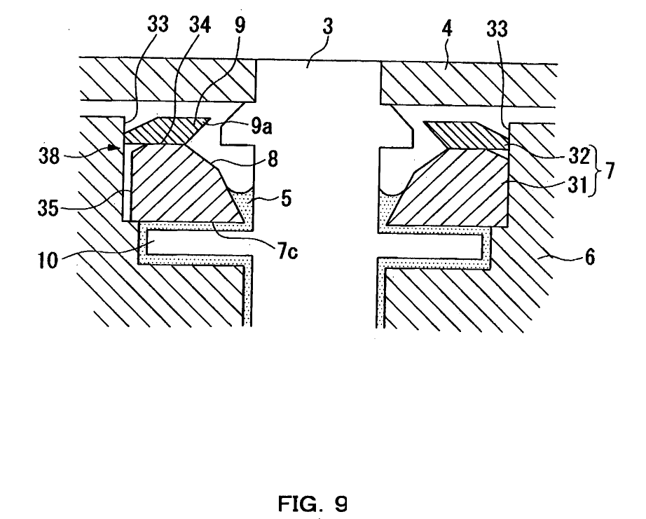

FIG. 9 is an enlarged sectional view of a main portion of a fluid dynamic pressure bearing device according to another embodiment;

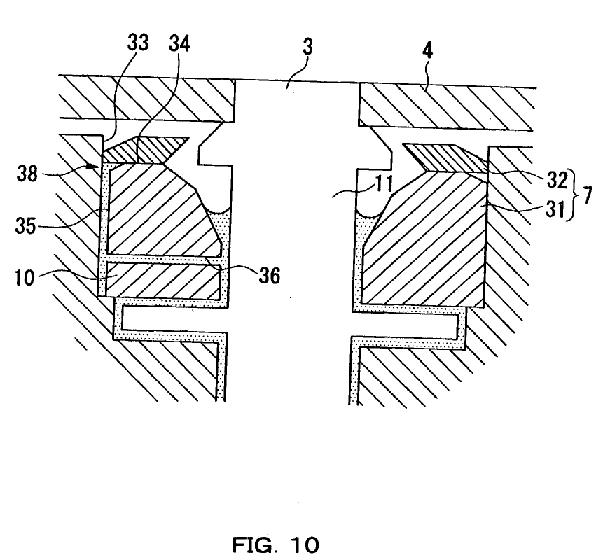

FIG. 10 is an enlarged sectional view of a main portion of a fluid dynamic pressure bearing device according to another embodiment;

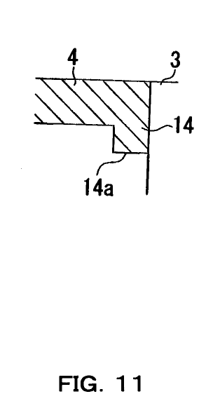

FIG. 11 is an enlarged sectional view of a main portion of a fluid dynamic pressure bearing device according to another embodiment;

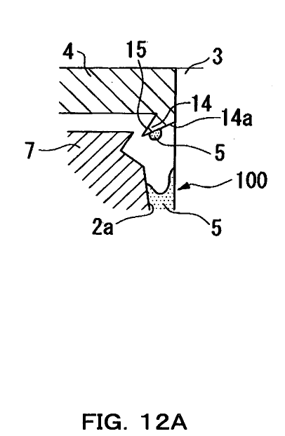

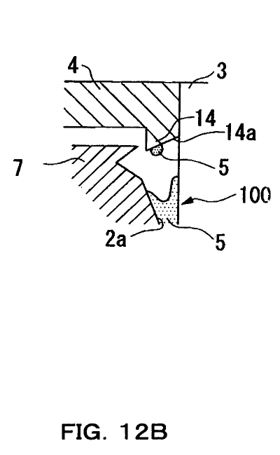

FIGS. 12A and 12B are enlarged sectional views of a main portion of a fluid dynamic pressure bearing device according to another embodiment;

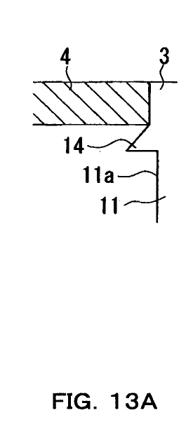

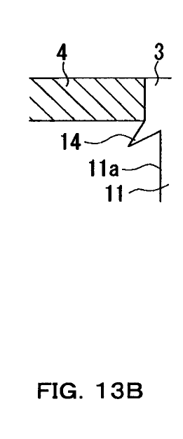

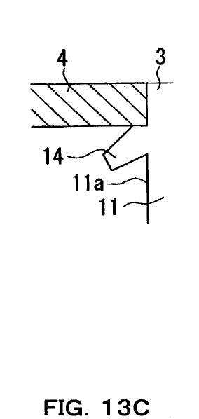

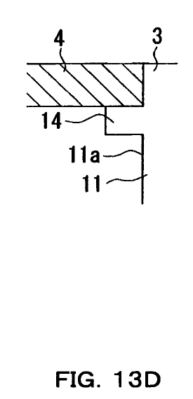

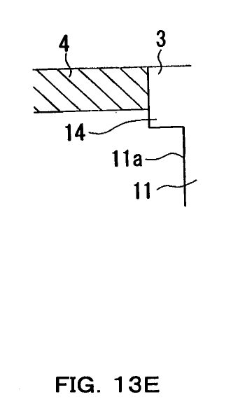

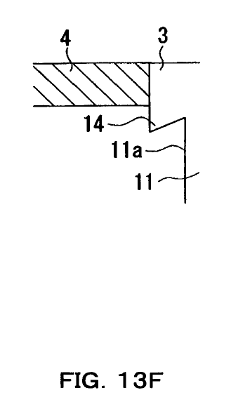

FIGS. 13A through 13F are enlarged sectional views of a main portion of a fluid dynamic pressure bearing device according to another embodiment;

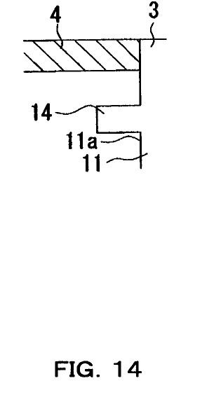

FIG. 14 is an enlarged sectional view of a main portion of a fluid dynamic pressure bearing device according to another embodiment;

FIG. 15 is a sectional view showing an example of a conventional fluid dynamic pressure bearing device;

FIG. 16 is an enlarged sectional view of a main portion of the fluid dynamic pressure bearing device of FIG. 15; and

FIG. 17 is an enlarged sectional view of the main portion of the fluid dynamic pressure bearing device of FIG. 15, showing how an oil cutoff groove is formed in the shaft member.

### DESCRIPTION OF THE PREFERRED EMBODIMENTS

FIGS. 1 through 5 are diagrams showing a first embodiment of the present invention. A fluid dynamic pressure bearing device of this embodiment is applied to a recording medium driving device which rotates a disc-shaped recording medium such as a magnetic recording medium formed as a thin disc. As shown in FIG. 1, a fluid dynamic pressure bearing device 1 is equipped with a sleeve (shaft member support portion) 2 having a shaft member insertion hole 2a that is substantially cross-shaped in section, a shaft member 3 which is inserted into the shaft member insertion hole 2a of the sleeve 2 so as to leave a predetermined clearance and which is formed as a cylinder that is substantially cross-shaped in section, a hub 4 mounted to the upper end portion of the shaft member 3, and an oil (liquid) 5 filling the clearance between the shaft member insertion hole 2a and the shaft member 3.

The sleeve 2 is composed of a sleeve main body 6 formed as a bottomed cylinder having a hole 6a constituting the shaft member insertion hole 2a, and an upper plate 7 closing the opening of the hole 6a of the sleeve main body 6 so as to leave a clearance between the upper plate 7 and the shaft member 3, with the upper end portion of the shaft member 3 protruding.

The upper plate 7 is formed substantially as a disc having a through-hole 7a extending in the direction of the central axis A1 of the upper plate 7. This through-hole 7a constitutes the shaft member insertion hole 2a together with the hole 6a of the sleeve main body 6, and diverges conically along the central axis A1 toward the surface 7b opposed to the hub 4.

As shown in FIG. 2, an inner wall surface 8 of the through-hole 7a is composed of a first inner wall surface 8a formed on the back surface 7c side of the upper plate 7, and a second inner wall surface 8b formed on the surface 7b side of the upper plate 7, with the inclination angle of the second inner wall surface 8b with respect to the central axis A1 being larger than that of the first inner wall 8a.

Utilizing capillarity, the first inner wall surface 8a prevents the oil 5 in the clearance between the sleeve 2 and the shaft member 3 from flowing out. That is, due to the first inner wall surface 8a and the outer peripheral surface of the shaft member 3 opposed to the first inner wall surface 8a, a capillary force directed to the back surface 7c side of the upper plate 7 acts on the oil 5.

Formed on the second inner wall surface 8b is an annular protrusion (axial-support protrusion) 9 protruding inwardly in the radial direction of the upper plate 7, with the protrusion 9 being formed at a position spaced apart from the surface of the oil 5.

As shown in FIG. 1, the shaft member 3 is equipped with a thrust shaft portion 10 formed substantially as a disc, and a substantially columnar radial shaft portion (columnar portion) 11 protruding in the direction of the central axis A1 from the surface 10a and the back surface 10b of the thrust shaft portion 10. Of the radial shaft portion 11, the outer peripheral surface 11a of the portion protruding on the back surface 10b side of the thrust shaft portion 10 has a plurality of dynamic pressure generating grooves 12 formed in a so-called herringbone configuration. Further, a plurality of spiral dynamic pressure generating grooves (not shown) are formed in the surface 10a and the back surface 10b of the thrust shaft portion 10.

When the shaft member 3 is rotated around the central axis A1, these dynamic pressure generating grooves collect the oil 5 to generate dynamic pressure, thereby enabling the sleeve 2 to support the shaft member 3 so as to allow mutual rotation. That is, the dynamic pressure of the oil 5 generated in the dynamic pressure generating grooves 12 of the radial shaft portion 11 serves as a radial bearing for the shaft member 3, and the dynamic pressure of the oil 5 generated in the dynamic pressure generating grooves of the thrust shaft portion 10 serves as a bearing for the shaft member 3 in the direction of the central axis A1.

The shaft member insertion hole 2a, the shaft member 3, the oil 5, and the dynamic pressure generating grooves constitute a dynamic pressure generating portion 100.

In the upper end portion of the shaft member 3, there is formed a columnar fit-engagement portion 13 having a diameter smaller than that of the radial shaft portion 11 and adapted to be fitted into a through-hole of the hub 4 described below.

The hub 4 is formed as a bottomed cylinder, and has at the center of its bottom wall portion 4c a through-hole 4a into which the fit-engagement portion 13 of the shaft member 3 is fitted. As shown in FIG. 2, in the peripheral edge of the through-hole 4a of the hub 4, there is formed an annular protrusion (shaft member protrusion) 14 protruding from the surface 4b opposed to the surface 7b of the upper plate 7. When brought into fitting engagement with the fit-engagement portion 13 of the shaft member 3, the lower end surface (liquid cutoff surface) 14a of this protrusion 14 abuts the forward end surface 11b of the radial shaft portion 11, whereby the positional relationship between the shaft member 3 and the hub 4 can be easily determined.

With the fit-engagement portion 13 fitted into the through-hole 4a, the protrusion 14 protrudes radially outwards from the outer peripheral surface 11a of the radial shaft portion 11. Further, the lower end surface 14a of the protrusion 14 is raised vertically from the outer peripheral surface 11a toward the second inner wall surface b. Thus, if, during rotation of the shaft member 3, the oil adhering to the lower end surface 14a is scattered radially outwards along the lower end surface 14a, the oil adheres to the second inner wall surface 8b.

The protrusion 9 formed on the upper plate 7 is formed at a position more spaced apart from the surface of the oil 5 than the position where the extension line of the lower end surface 14a crosses the second inner wall surface 8b.

On the outer peripheral surface side of the base portion of the protrusion 14, there is formed an annular oil trapping groove 15, which traps the oil 5 scattered through the clearance between the protrusion 9 and the protrusion 14.

Further, an oil-repellent consisting of polytetrafluoroethylene (PTFE) is applied to the lower end surface 9a of the protrusion 9 adjacent to the second inner wall surface 8b, and to the lower end surface 14a and the outer peripheral surface 14b of the protrusion 14. The oil-repellent serves to reduce the adhesion force with which the oil 5 adheres to the lower end surface 9a of the protrusion 9 and to the lower end surface 14a and the outer peripheral surface 14b of the protrusion 14. Further, the oil-repellent is applied in fine speckles, allowing adhesion of fine droplets of the oil 5 to the lower end surface 9a, the lower end surface 14a, and the outer peripheral surface 14b.

As shown in FIG. 1, this fluid dynamic pressure bearing device 1 is equipped with driving means 20 for rotating the shaft member 3 and the hub 4. This driving means 20 is equipped with a core 22 and a coil 23 that are arranged in the periphery of the sleeve 2, and a magnet 24 arranged at a position on the hub 4 opposed to the core 22 and the coil 23. The shaft member 3 and the hub 4 are rotated by applying an alternating magnetic field generated in the core 22 and the core 23 to the magnet 24.

The fluid dynamic pressure bearing device 1 and the driving means 20 constitute a motor 25.

Further, in the periphery of the bottom wall portion 4c of the hub 4, there is formed a step portion 4d for supporting a disc-type recording medium 30. By fitting a central hole 30a formed at the center of the disc-type recording medium 30 onto this step portion 4d, it is possible for the disc-type recording medium 30 to rotate around the central axis A1 together with the shaft member 3 and the hub 4.

The hub 4 equipped with the step portion 4d and the motor 25 constitute a recording medium driving device 40.

Next, an operation of the fluid dynamic pressure bearing device 1 will be described.

When the shaft member 3 is rotated around the central axis A1 by the driving force of the motor 25, the sleeve 2 rotatably supports the shaft member 3 by the dynamic pressure generated in the dynamic pressure generating grooves. Further, as shown in FIG. 3, the oil 5 is attracted to the outer peripheral surface 11a side of the shaft member 3 in this process, so that the liquid level of the oil 5 rises along the outer peripheral surface 11a as indicated by an arrow F3. The oil 5 thus rising adheres to the lower end surface 14a of the protrusion 14 and is accumulated there. When the amount of oil 5 thus accumulated exceeds a fixed level, the oil drops by gravity as indicated by an arrow F4, and returns to the clearance between the shaft member insertion hole 2a and the shaft member 3.

Further, as shown in FIG. 4, when the oil 5 adhering to the lower end surface 14a of the protrusion 14 is scattered radially outwards (as indicated by an arrow F5) by the centrifugal force generated by the rotation of the shaft member 3 and the hub 4 before the accumulated oil reaches the above-mentioned fixed amount level, the oil adheres to the second inner wall surface 8b. When the amount of the oil 5 thus adhering to the second inner wall surface 8b exceeds a fixed level, the oil flows down by gravity along the inner wall surface 8b as indicated by an arrow F6, and recovered in the clearance between the sleeve 2 and the shaft member 3.

Further, even if the oil 5 adhering to the second inner wall surface 8b moves in a direction opposite to the direction F6 along the second inner wall surface, the oil abuts the lower end surface 9a of the protrusion 9, so that it is possible to restrain scattering of oil to the outside of the clearance between the protrusion 9 and the protrusion 14. When the amount of oil 5 adhering to the lower end surface 9a exceeds a fixed level, the oil drops by gravity in the direction of an arrow F7 as shown in FIG. 5, and flows down along the second inner wall surface 8b.

If some oil should be scattered outwardly through the clearance between the protrusion 9 and the protrusion 14 along the lower end surface 9a before the amount of oil 5 adhering to the lower end surface 9a exceeds the above-mentioned fixed level, that oil would be accommodated in the oil trapping groove 15 formed in the protrusion 14.

When the shaft member 3 rotates, the oil 5 is heated to be partially turned into a mist. By minimizing the clearance between the protrusion 9 and the protrusion 14, it is possible to minimize outward leakage of oil in the form of mist. Further, since the oil in the form of a mist consists of fine droplets, it is possible to restrain outward leakage of mist oil by causing these fine droplets to adhere to the lower end surface 9a of the protrusion 9 and to the lower end surface 14a and the outer peripheral surface 14b of the protrusion 14.

As described above, in this fluid dynamic pressure bearing device 1, even when the shaft member 3 rotates, outward leakage of oil 5 through the clearance between the sleeve 2 and the shaft member 3 is prevented, and the portion of the oil 5 that has moved away from the dynamic pressure generating portion 100 can be recovered in the dynamic pressure generating portion 100, so that it is possible to maintain stable bearing properties of the dynamic pressure generating portion 100 for a long period of time.

Further, when this fluid dynamic bearing device 1 is applied to the motor 25, the bearing properties of the dynamic pressure generating portion 100 do not change even if the motor 25 is used for a long period of time, so that it is possible to realize a stable rotation of the shaft member 3. Thus, the control of the driving force of the driving means 20 is facilitated, and it is possible to save the requisite energy for driving.

Further, when this fluid dynamic bearing device 1 is applied to the recording medium driving device 40 for rotating the disc-type recording medium 30, no liquid adheres to the surface of the disc-type recording medium 30, so that it is possible to avoid problems when writing or reading data to or from the disc-type recording medium 30.

Next, FIG. 6 shows a second embodiment of the present invention. This embodiment is basically of the same construction as the fluid dynamic pressure bearing device 1 shown in FIGS. 1 through 5 except for the configuration of the through-hole 7a of the upper plate 7. Here, with reference to FIG. 6, the configuration of the through-hole 7a will be described. The components that are the same as those shown in FIGS. 1 through 5 are indicated by the same reference numerals, and a description of such components will be omitted.

As shown in FIG. 6, the inner wall surface 8 of the through-hole 7a is composed of a first inner wall surface (tapered inner wall surface) 8a and a second inner wall surface (outer inner wall surface) 8b. As in the above embodiment, the first inner wall surface 8a is formed such that the through-hole 7a diverges toward the surface 7b of the upper plate 7. Further, the second inner wall surface 8b is adjacent to the large diameter side of the first inner wall surface 8a, and is parallel to the central axis A1.

Further, the outer peripheral surface 14b of the protrusion 14 formed on the hub 4 is formed so as to be parallel to the central axis A1 and opposed to the second inner wall surface 8b, whereby it is possible to make the clearance S between the second inner wall surface 8b and the outer peripheral surface 14b of the protrusion 14 narrow, thereby making it possible to make the length of the clearance S as measured along the central axis A1 large.

As in the above-described embodiment, an oil-repellent consisting of polytetrafluoroethylene (PTFE) is applied to the lower end surface 14a and the outer peripheral surface 14b of the protrusion 14 and to the second inner wall surface 8b of the upper plate 7. The oil-repellent serves to reduce the adhesion force with which the oil 5 adheres to the lower end surface 14a and the outer peripheral surface 14b of the protrusion 14 and to the second inner wall surface 8b. Further, the oil-repellent is applied in fine speckles, allowing adhesion of fine droplets of the oil 5 to the lower end surface 14a, the outer peripheral surface 14b, and the second inner wall surface 8b.

In the above-described construction, when the shaft member 3 and the hub 4 rotate, the oil 5 adhering to the lower end surface 14a is scattered in the radial direction of the shaft member 3, and adheres to the first inner wall surface 8a and the second inner wall surface 8b. When the oil 5 adhering to the second inner wall surface 8b flows down by gravity along the second inner wall surface 8b, or when the oil 5 adhering to the first inner wall surface 8a moves toward the second inner wall surface 8b along the first inner wall surface 8a, the oil 5 reaches a corner portion 8c formed by the first inner wall surface 8a and the second inner wall surface 8b, and stays in this corner portion 8c due to surface tension.

Here, it is desirable that the angle θ made by the first inner wall surface 8a and the second inner wall surface 8b in this corner portion 8c be in the range of 95°≦θ≦130°. The reason for setting this angle θ at 95° or more is to prevent a large amount of oil 5 from being accumulated in the corner portion 8c due to surface tension and to prevent the oil 5 from overflowing and scattering to the outside of the clearance between the sleeve 2 and the shaft member 3.

Further, the reason for setting the angle θ at 130° or less is to cause a small amount of oil 5 to stay due to surface tension when the oil 5 adhering to the first inner wall 8a moves along the first inner wall surface 8a to reach the corner portion 8c, thereby preventing the oil 5 from easily getting over the corner portion 8c and scattering along the second inner wall surface 8b to the outside of the clearance between the sleeve 2 and the shaft member 3.

As described above, in this fluid dynamic pressure bearing device 1, the angle θ of the corner portion 8c is within the range of 95°≦θ≦130°, whereby a small amount of oil 5 is accumulated in the corner portion 8c, making it possible to move the oil 5 to the dynamic pressure generating portion 100 side before a large amount of oil 5 is accumulated. As a result, it is possible to prevent the oil 5 from being scattered to the outside of the clearance between the sleeve 2 and the shaft member 3. Further, the oil 5 accumulated in the corner portion 8c can be recovered in the dynamic pressure generating portion 100, so that it is possible for the dynamic pressure generating portion 100 to maintain stable bearing properties for a long period of time.

Further, since the angle θ of the corner portion 8c is 95° or more, it is possible to form the through-hole 7a accurately and easily by machining.

Further, when the shaft member 3 rotates, the oil 5 is heated and is partially evaporated to be turned into a mist. However, since the narrow clearance S between the second inner wall surface 8b and the protrusion 14 is formed so as to extend over a long distance along the central axis A1, it is possible to restrain outward leakage of the oil in the form of a mist. Further, outward leakage of the oil in the form of a mist, which consists of fine droplets, can be prevented by causing the fine droplets to adhere to the lower end surface 14a, the outer peripheral surface 14b, and the second inner wall surface 8b.

Further, since the oil-repellent is applied to the second inner wall surface 8b and the outer peripheral surface 14b of the protrusion 14, it is possible to prevent the oil 5 from being accumulated in the narrow clearance S due to surface tension when filling the clearance between the sleeve 2 and the shaft member 3 with the oil 5 poured in through the clearance S, making it possible to perform the filling of the oil 5 smoothly. Thus, it is possible to easily prevent intrusion of bubbles into the clearance between the sleeve 2 and the shaft member 3 when filling the oil 5.

While in the first embodiment the oil-repellent is applied to the lower end surfaces 9a and 14a of the protrusions 9 and 14 and to the outer peripheral surface 14b, this should not be construed restrictively. In addition to these surfaces, it is also possible to apply the oil-repellent to the surface 7b of the upper plate 7, the surface 4b of the hub 4 opposed to the surface 7b, the surface of the oil trapping groove 15, etc., i.e., surfaces situated on the outer side of the clearance between the sleeve 2 and the shaft member 3.

Further, while in the above example the second inner wall surface 8b is formed such that the through-hole 7a diverges conically, this should not be construed restrictively. For example, as shown in FIG. 7, it is also possible to form the surface such that it extends along the axial direction of the shaft member 3. Further, it is also possible for the second inner wall surface 8b to be formed, for example, at the same inclination angle as the first inner wall surface 8a.

Further, as shown, for example, in FIG. 8, it is also possible to adopt a construction in which the upper plate 7 is composed of a first plate member 31 having the inner wall surface 8 and a second plate member 32 having the protrusion 9. In this case, it is possible to form the inner wall surface 8 and the protrusion 9 of the upper plate 7 separately, so that the manufacture of the upper plate 7 is facilitated.

Further, as shown, for example, in FIG. 9, it is possible to provide the upper plate 7 with an oil recovery passage 38, which is composed of a through-hole 34 with a minute diameter extending from the inner wall surface 8 toward the inner wall surface 33 of the sleeve main body 6, and a through-groove portion 35 extending along the inner wall surface 33 to the back surface 7c side of the upper plate 7.

In this case, it is possible to recover the oil adhering to the inner wall surface 8 and the lower end surface 9a of the protrusion 9 inside the through-hole 34 by capillary force, and to recover the oil inside the clearance between the thrust shaft portion 10 and the upper plate 7 along the through-groove portion 35.

Further, as shown, for example, in FIG. 10, it is also possible to provide the oil recovery passage 38 with a through-hole 36 extending from the through-groove portion 35 toward the radial shaft portion 11. In this case, the oil recovered in the through-groove portion 35 can be recovered in the clearance between the thrust shaft portion 10 and the upper plate 7, and in the clearance between the radial shaft portion 11 and the upper plate 7.

Further, as shown in FIGS. 9 and 10, the through-hole 34 of the oil recovery passage 38 may be formed by two plate members 31 and 32, or a single upper plate 7.

While in the second embodiment the oil-repellent is applied to the lower end surface 14a and the outer peripheral surface 14b of the protrusion 14, and the second inner wall surface 8b of the upper plate 7, this should not be construed restrictively. In addition to these surfaces, it is also possible to apply the oil-repellent to the surface 7b of the upper plate 7, the surface 4b of the hub 4 opposed to the surface 7b, the surface of the oil trapping groove 15, etc., that is, surfaces situated on the outer side of the clearance between the sleeve 2 and the shaft member 3.

Further, while in the above embodiment the second inner wall surface 8b is formed so as to be parallel to the central axis A1, this should not be construed restrictively. It is also possible for the second inner wall surface 8b to be formed so as to be slightly inclined with respect to the central axis A1. In this case, it is desirable for the angle made by the second inner wall surface 8b and the central axis A1 to be 3 degrees or less so that the machining of the through-hole 7a may be facilitated.

Further, it is not always necessary for the outer peripheral surface 14b of the protrusion 14 to be formed parallel to the central axis A1; it may also be formed so as to be slightly inclined with respect to the central axis. In this case, it is desirable for the outer peripheral surface 14b to be formed so as to be parallel to the second inner wall surface 8b so that the narrow clearance S can extend over a long distance along the central axis A1.

Further, as described above, the upper plate 7 may be composed of a first plate member having the first inner wall surface 8a and a second plate member having the second inner wall surface 8b, and it is also possible to form the oil recovery passage as described above between these two plate members.

While in the first and second embodiments the oil-repellent consists of polytetrafluoroethylene (PTFE), this should not be construed restrictively. Any type of oil-repellent will do as long as it is repellent at least to the oil 5. Thus, it is also possible, for example, for the oil-repellent to consist of an epoxy type resin.

Further, while in the above embodiments the diameter of the fit-engagement portion 13 of the shaft member 3 is smaller than the diameter of the radial shaft portion 11, this should not be construed restrictively. There is no particular limitation regarding these diameters as long as fit-engagement of the fit-engagement portion 13 with the through-hole 4a of the hub 4 is possible. Thus, for example, this fit-engagement portion 13 may have the same diameter as the radial shaft portion 11.

Further, while in the above embodiments a plurality of herringbone-shaped dynamic pressure generating grooves 12 are formed in the outer peripheral surface 11a of the radial shaft portion 11, this should not be construed restrictively. It is also possible to form the dynamic pressure generating grooves 12 in the inner wall surface of the hole 6a of the sleeve main body 6 opposed to this outer peripheral surface 1a, or in both the outer peripheral surface 11a and the inner wall surface of the hole 6a.

Further, while in the above embodiments a plurality of spiral dynamic pressure generating grooves are formed in the surface 10a and the back surface 10b of the thrust shaft portion 10, this should not be construed restrictively. It is also possible, for example, to form these dynamic pressure generating grooves in the inner wall surface of the hole 6a opposed to the surface 10a and the back surface 10b and in the back surface 7c of the upper plate 7, or both in the surface 10a and the back surface 10b and in the inner wall surface of the hole 6a and the back surface 7c. Further, the configuration of the dynamic pressure generating grooves of the thrust shaft portion 10 is not restricted to the spiral one; it may also be a herringbone-like configuration.

Further, while in the above embodiments the oil trapping groove 15 is provided in the protrusion 14, it is also possible to provide no such oil trapping groove as shown, for example, in FIG. 11.

Further, while in the above embodiments the lower end surface 14a of the protrusion 14 is raised vertically from the outer peripheral surface 11a of the radial shaft portion 11 toward the second inner wall surface 8b, it suffices for the lower end surface 14a to be raised at least toward the inner wall surface 8. That is, as shown, for example, in FIGS. 12A and 12B, this lower end surface 14a may be formed as a tapered inner surface whose diameter gradually increases toward the dynamic pressure generating portion 100 along the axial direction of the shaft member 3.

In this case, even if the oil 5 adhering to the lower end surface 14a is scattered outwards in the radial direction of the shaft member 3 along the lower end surface 14a by the centrifugal force generated by the rotation of the shaft member 3 and the hub 4, the oil 5 moves toward the dynamic pressure generating portion 100. Thus, this oil 5 is returned to the clearance between the shaft member 3 and the shaft member insertion hole 2a, making it possible to maintain stable bearing properties for the dynamic pressure generating portion 100 for a long period of time.

Further, while in the above embodiments the protrusion 14 is formed in the periphery of the through-hole 4a of the hub 4, this should not be construed restrictively. It is only necessary for the protrusion 14 to annularly protrude toward the inner wall surface 8 from the outer peripheral surface 11a of the radial shaft portion 11 situated axially on the outer side of the dynamic pressure generating portion 100. That is, as shown, for example, in FIGS. 13A through 13F, the protrusion 14 may also be formed integrally with the radial shaft portion 11.

Further, as shown in FIGS. 13A through 13D, the protrusion 14 formed on the radial shaft portion 11 may serve as an abutment portion for performing positioning on the shaft member 3 and the hub 4 when the hub 4 and the shaft member 3 are brought into fit-engagement with each other, or, as shown in FIGS. 13E and 13F, it may not function as an abutment portion.

Further, it is not necessary for this protrusion 14 to be adjacent to the hub 4. For example, as shown in FIG. 14, the protrusion 14 may be spaced apart from the hub 4 along the axial direction of the shaft member 3.

Further, while in the above embodiments the sleeve 2 is composed of the sleeve main body 6 formed as a bottomed cylinder and the upper plate 7, this should not be construed restrictively. Any type of construction will do as long as it allows insertion of the shaft member 3. For example, the sleeve main body 6 may be composed of a cylindrical member with a through-hole and a counter plate closing the lower opening of the through-hole.

Further, while in the above embodiments the shaft member 3 is formed so as to be cross-shaped in section, this should not be construed restrictively. For example, it is also possible to form the thrust shaft portion 10 at the lower end of the radial shaft portion 11, forming the shaft member 3 in a reverse-T shape in section.

Further, while in the above embodiments the hub 4 is mounted to the shaft member 3, this should not be construed restrictively. For example, it is also possible to integrate the hub 4 and the shaft member 3 with each other.

Further, while in the above embodiments the driving means 20 for the motor 25 is composed of the core 22 and the coil 23 that are provided in the sleeve 2 and the magnet 24 that is provided on the hub 4, this should not be construed restrictively. Any type of driving means will do as long as it is capable of rotating the shaft member 3 and the hub 4.

The above embodiments of the present invention, described in detail with reference to the drawings, should not be construed restrictively. Various modifications in design, etc. are possible without departing from the gist of the present invention.

As described above, in accordance with the present invention, it is possible to prevent liquid from being scattered outwardly through the clearance between the shaft member support portion and the shaft member, and to recover in the clearance the oil that is spaced apart from the dynamic pressure generating portion, so that it is possible to maintain stable bearing properties for the dynamic pressure generating portion for a long period of time.

Further, in the case in which this fluid dynamic pressure bearing device is provided in a motor, it is possible to realize a stable rotation of the shaft member, so that the control of the driving force of the driving means is facilitated, and it is possible to save the requisite energy for driving.

Further, in the case in which this fluid dynamic pressure bearing device is provided in a recording medium driving device, no liquid adheres to the surface of the recording medium, so that it is possible to avoid problems when writing or reading data to or from the recording medium.

1. A fluid dynamic pressure bearing devices comprising:
a shaft member having a columnar portion formed substantially in a columnar configuration;
a shaft member support portion having a shaft portion insertion hole for accommodating the shaft member; and
a dynamic pressure generating portion formed by filling a clearance defined between the shaft member and the shaft member insertion hole with a liquid, with at least one of a surface of the shaft member and an inner wall surface of the insertion hole being equipped with a dynamic pressure generating groove for collecting the liquid to generate dynamic pressure when the shaft member is rotated around its axis,
wherein an annular shaft member protrusion protruding radially outwards is provided on an outer peripheral surface of the columnar portion situated axially on an outer side of the dynamic pressure generating portion.

2. A fluid dynamic pressure bearing device according to claim 1, wherein the shaft member protrusion has a liquid cutoff surface raised from the outer peripheral surface of the columnar portion toward the inner wall surface.

3. A fluid dynamic pressure bearing device according to claim 2, wherein the cutoff surface is formed as a tapered inner surface whose diameter increases gradually along an axial direction of the shaft member toward the dynamic pressure generating portion.

4. A fluid dynamic pressure bearing device according to claim 2, further comprising an annular axial-support protrusion protruding radially inwards which is provided on the inner wall surface situated on an axially outer side of the dynamic pressure generating portion and more spaced apart from the dynamic pressure generating portion than a position where an extension line of the liquid cutoff surface crosses the inner wall surface.

5. A fluid dynamic pressure bearing device according to claim 2, wherein:
the inner wall surface of the insertion hole situated axially on the outer side of the dynamic pressure generating portion is equipped with a tapered inner wall surface whose diameter gradually decreases along the axial direction of the shaft member toward the dynamic pressure generating portion, and an outer inner wall surface adjacent to a large diameter side of the tapered inner wall surface;
one of the tapered inner wall surface and the outer inner wall surface crosses the extension line of the liquid cutoff surface; and
an angle θ made by the tapered inner wall surface and the outer inner wall surface is in a range of 95°≦θ≦130°.

6. A fluid dynamic pressure bearing device according to claim 5, wherein the outer inner wall surface is formed so as to be substantially parallel to the axial direction of the shaft member.

7. A motor, comprising:
the fluid dynamic pressure bearing device according to claim 1; and
driving means for rotating the shaft member with respect to the shaft member support portion.

8. A recording medium driving device, comprising:
the motor according to claim 7; and
a hub supporting a thin-plate-like recording medium which is mounted to the shaft member.
